(19) United States
(12) Patent Application Publication
(10) Pub. No.: US 2003/0158797 A1
(43) Pub. Date: Aug. 21, 2003

(54) Method for sharing expenditure of distribution system

(76) Inventor: Yi Ming Liao, Taipei (TW)

Correspondence Address: JACOBSON HOLMAN PLLC, 400 SEVENTH STREET N.W., SUITE 600, WASHINGTON, DC, 20004, US

(21) Appl. No.: 10/075,266

(22) Filed: Feb. 15, 2002

(51) Int. Cl. G06F 17/60

(52) U.S. Cl. 705/30

(57) ABSTRACT

A method for sharing expenditure of distribution system, designed to resolve the internal dilemma of enterprises being unable to accurately calculate and utilize system resources. Through the statistical system's dynamic monitoring conducted separately on the various departments with regards to the situation of their use of resources, as well as demanding the sharing of the system's maintenance expenditures, a reduction in the cost of the enterprise's system maintenance is facilitated.

### FIELD OF THE INVENTION

The invention relates to a method for managing system resources, and more particularly, to a method that applies to a resource statistics system and controls the ways of using the system, with a view to making individual departments of an enterprise share the expenditures of a distribution system.

### RELATED ART

From the point of view of most enterprises or manufacturers, there are many methods for increasing profitability, and cost management is one of these methods. Among different kinds of costs, the management of the cost of system maintenance is one to which dealers attach great importance. Dealers always expend a considerable amount of manpower, material resources and financial resources to carry out the maintenance of their systems so as to ensure their stable functioning. However, this is an expensive method, and some dealers require individual departments to manage the resources or impose restrictions on the use of part of the systems. Some dealers require departments that make relatively large profits, such as the business department or sales department, to pay the system maintenance fees. Nevertheless, this method provides a temporary solution to the problem, but it does not get at the root, nor is it fair, as it often causes conflicts between individual departments. Enterprises still have to pay a considerable amount for system maintenance fees and thus they are unable to reduce their operation costs. Their staff does not economize the use of system resources, and therefore the expenditures increase.

In addition, most enterprises are unable to manage individual departments' use of system resources separately. An accurate assessment is impossible, even with a working flow process of calculation. Therefore, a method for sharing expenditures of a distribution system of an enterprise has become a topic worthy of concern.

### SUMMARY OF THE INVENTION

In view of this, a method for sharing expenditures of a distribution system is put forth, with a view to solve the aforesaid problem. The primary object of the invention is to control the use of all system resources through a resource statistics system. Individual departments are required to pay for system maintenance on a pro-rata basis. In the course of processing, information that is to be filed is stored in a database, the use of system resources by a specific department is calculated according to a specific cycle, and decision-makers are provided with data for reference. Individual departments are required to share the cost of system maintenance in a reasonable manner, according to the proportion of system resources they utilize. This effectively avoids the abuse of system resources, with a view to optimizing the use of the internal resources of an enterprise, and enabling the enterprise to make greater profits.

The method for sharing expenditures of a distribution system, put forth by the invention, at least comprises the following steps: firstly, a resource statistics system receives a signal that denotes a user-end's login to an enterprise's server. Then the data used by the user-end is recorded by means of the resources statistical system. The amount of expenditure to be shared by individual departments is calculated in accordance with the usage data of at least one department. The amount of expenditure to be shared by individual departments is written into the resources statistical system, according to a specific cycle. Eventually, the amount of expenditure to be shared by individual departments is included in the expenditure statistical checklists of individual departments.

To further expound on the detailed contents and technology of the invention, drawings are given below to illustrate the invention in detail.

### BRIEF DESCRIPTION OF THE DRAWINGS

FIG. 1-a is a flowchart of the method for sharing expenditures of a distribution system, put forth by the invention;

FIG. 1-b is a flowchart of the method for sharing expenditures of a distribution system, put forth by the invention; and

FIG. 1-c is a flowchart of the method for sharing expenditures of a distribution system, put forth by the invention.

### DETAILED DESCRIPTION OF THE INVENTION

The invention puts forward a method for sharing expenditures of a distribution system, and more particularly, a method designed for enterprises' Business Process Reengineering (BPR), advocated by the market nowadays. It's aim is to use and manage the resources of the enterprises in an efficient way, re-construct the working process of sharing the maintenance cost of system resources, enhance the effects and benefits of the usage of the enterprises' resources, and reduce risk factors, with a view to cutting operation costs.

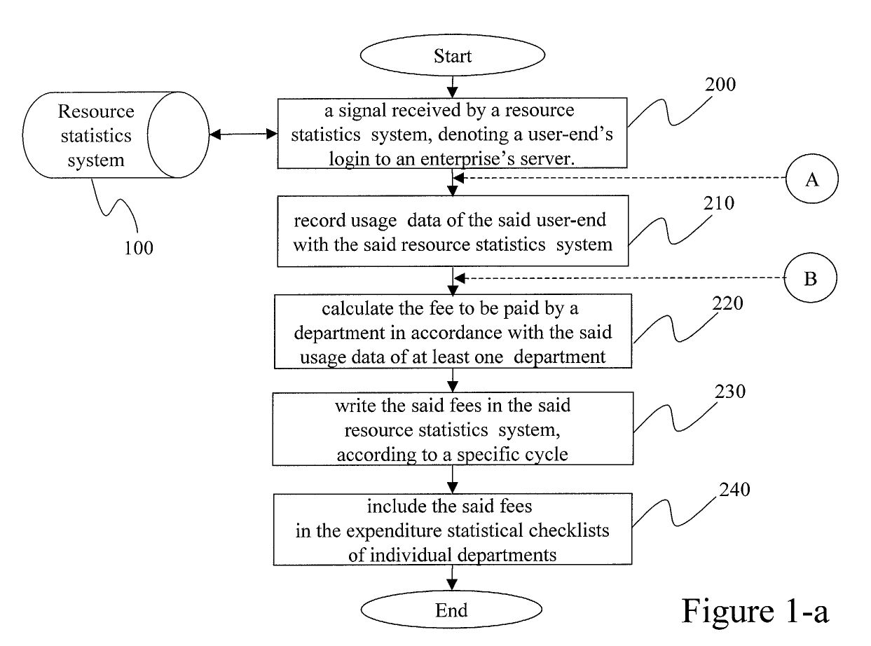

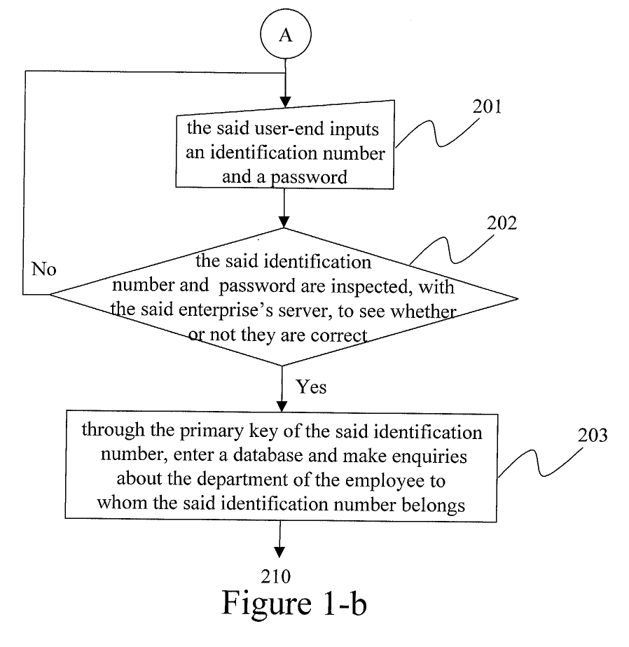

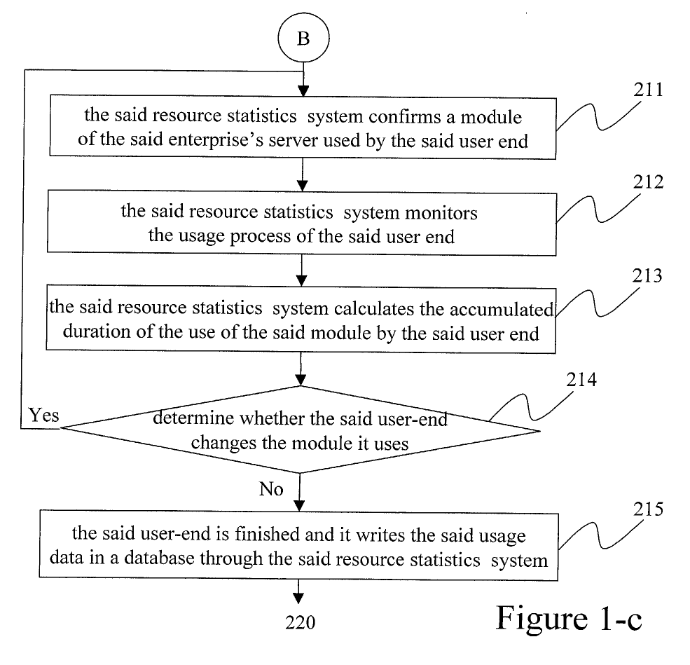

The feasibility of the invention is illustrated by means of a preferred embodiment. Please refer to FIG. 1-a, which shows a flowchart of the method for sharing expenditures of a distribution system, put forth by the invention. Explanation is as follows:

Firstly, a resource statistics system 100 receives a signal that denotes a user-end's login to an enterprise's server (step 200). The process of receiving a signal that denotes a user-end's login to an enterprise's server is known as step A. The resource statistics system 100 analyzes the source of the user end. Then the data used by the user-end is recorded by means of the resource statistics system (step 210). The process of recording the data used by the user-end through the resource statistics system 100 is known as step B. After the recording process, the amount of expenditure to be paid by a department is calculated in accordance with the usage data of at least one department (step 220). The amount of expenditure to be paid by the department is written into the resource statistics system, according to a specific cycle (step 230). The specific cycle is defined by an enterprise on its own. Eventually, the amount of expenditure to be shared by individual departments is included in the expenditure statistical checklists of individual departments (step 240)

The aforesaid enterprise' servers are used in managing the allocation and integration of all the resources available within an enterprise, monitoring messages for abnormality of any kind, and they are linked together by an internal network of the enterprise that can be an Ethernet.

The aforesaid step of informing the department of required payment and requesting the department to make a payment can be performed by sending emails automatically to the department through an Executive Information System (EIS). The Executive Information System screens and selects various types of intrinsic and extrinsic information, gives a prompt as to the condition of the said user-end's deviation from a plan, and sends a warning to every related superior.

Please refer to FIG. 1-a, which shows a flowchart of the method for sharing expenditures of a distribution system. FIG. 1-a illustrates the process following step A.

Firstly, the user-end inputs an identification number and a password (step 201). The identification number (ID) is a serial number provided by the enterprise end to identify an employee's identity. After a signal has been received, the identification number and password are inspected, with the said enterprise's server, to see whether or not they are correct (step 202). If they are not correct, then return to step 201. If they are correct, enter a database to make enquiries about the department of the employee to whom the identification number belongs, through the primary key of the identification number (step 203). Return to step 210 again.

Please refer to FIG. 1-c, which shows a flowchart of the method for sharing expenditures of a distribution system. FIG. 1-a illustrates the process following step B.

First of all, the resource statistics system 100 confirms a module of the enterprise's server used by the user-end (step 211). After confirmation, the resource statistics system 100 monitors the usage process of the user-end (step 212). The usage process is defined by the enterprise on its own. The resource statistics system 100 calculates the accumulated duration of the use of the module by the user-end (step 213). The accumulated duration of use is temporarily stored in a register, and it is determined whether the user-end changes the module it uses (step 214). If it is determined that the user-end has changed the module it uses, then return to step 211 again. In the event that the user-end has not changed the module it uses, then the user-end is finished and it writes the usage data in a database through the resource statistics system (step 215) and returns to step 210 again.

The use of the different modules requires access to different kinds of system resources, though they are all monitored by the resource statistics system 100. The aforesaid database provides a plurality of data outlines and relation tables for storing related recorded data, and it can be a Structure Query Language (SQL) server.

The invention provides a decision-maker with a set of reference data, according to the condition of the use of system resources by specific departments. It enables individual departments to share the cost of system maintenance in a reasonable manner, according to the proportion of system resources they use, so as to effectively avoid the abuse of system resources, with a view to optimizing the use of the internal resources of an enterprise, and enabling the enterprise to make greater profits.

While the invention has been described by way of example and in terms of a preferred embodiment, it is to be understood that the invention is not limited thereto. It should be understood that the detailed description and specific examples, while indicating preferred embodiments of the invention, are given by way of illustration only, since various changes and modifications within the spirit and scope of the invention will become apparent to those skilled in the art from this detailed description. Therefore the scope of protection for the invention should conform to the claims attached below.

What is claimed is:

1. A method for sharing expenditure of distribution system, which applies to the management of the resources available within an enterprise, and carries out integration of the use of all system resources by users through a resource statistics system, individual departments are required to pay for system maintenance on a pro-rata basis so as to reduce the operation cost of the enterprise, which comprises the steps of:
receiving a signal that denotes a user-end's login to an enterprise's server;
recording a set of user-end's data by means of the resource statistics system;
calculating the amount of expenditure to be paid by a department in accordance with the usage data of at least a department;
according to a specific cycle, writing the amount of expenditure to be paid by the department into the resource statistics system,; and
including the amounts of expenditure to be shared by individual departments into the expenditure statistical checklists of individual departments.

2. The method for sharing expenditure of distribution system of claim 1, wherein the enterprise's servers are used in managing the allocation and integration of all the resources available within an enterprise, monitoring messages for abnormality of any kind, and they are linked together by an internal network of the enterprise.

3. The method for sharing expenditure of distribution system of claim 2, wherein the internal network (LAN) of the enterprise can be the Ethernet.

4. The method for sharing expenditure of distribution system of claim 1, wherein the step of the receipt of a signal, which denotes a user-end's login to an enterprise's server, by the resource statistics system further comprises the steps of:
inputting an identification number (ID) and a password;
checking the identification number (ID) and the password are correct or not;
entering a database to make enquiries about the department of the employee to whom the identification number (ID) belongs, through the primary key of the identification number (ID);

5. The method for sharing expenditure of distribution system of claim 4, wherein the identification number (ID) is a serial number provided by the enterprise end to identify an employee's identity.

6. The method for sharing expenditure of distribution system claim 1, wherein the step of recording the data used by the user-end by means of the resource statistics system further comprises the steps of:
confirming a module of the enterprise's server used by the user end;
monitoring the usage process of the user end;
calculating the accumulated duration of the use of the module by the user end;
determining whether the user-end changed the module it uses;
writing the usage data in a database through the resource statistics system.

7. The method for sharing expenditure of distribution system of claim 6, wherein the use of the different modules requires access to different kinds of system resources, though they are all monitored by the resource statistics system.

8. The method for sharing expenditure of distribution system of claim 6, wherein the database provides a plurality of data outlines and relation tables, for storing related recorded data.

9. The method for sharing expenditure of distribution system claim 6, wherein the database can be a Structure Query Language (SQL) server.

10. The method for sharing expenditure of distribution system claim 1, wherein the step of informing the department of making payment and requesting the department to make a payment can be performed by sending emails, automatically, to the department through an Executive Information System (EIS).

11. The method for sharing expenditure of distribution system claim 1, wherein the Executive Information System screens and selects various types of intrinsic and extrinsic information, gives a prompt as to the condition of the user-end's deviating from a plan, and sends a warning to every related superior.

12. The method for sharing expenditure of distribution system claim 1, wherein the specific cycle is defined by the enterprise on its own.
